(19) United States
(12) Patent Application Publication
(10) Pub. No.: US 2025/0148124 A1
(43) Pub. Date: May 8, 2025

(54) DATABASE ARCHITECTURE SUPPORTING ACCESS RIGHTS ACROSS DISPARATE USER PROFILE TYPES

(71) Applicant: Wells Fargo Bank, N.A., San Francisco, CA (US)

(72) Inventors: Peter Rozovski, Concord, CA (US); Peter L. Shen, Castro Valley, CA (US)

(21) Appl. No.: 18/503,488

(22) Filed: Nov. 7, 2023

(51) Int. Cl. G06F 21/62

(52) U.S. Cl. CPC G06F 21/6245

(57) ABSTRACT

A method may include receiving, from a computing device associated with a first user, an electronic request to delegate an electronic access right of an account of a user profile of the first user to a second user, the electronic request including an identifier of the second user; querying, using a processing unit, a database using the identifier of the second user; determining, using the processing unit, that the identifier of the second user is not present in the database based on a result of the querying; and as a result of the determining: generating, using the processing unit, a limited purpose user profile in the database for the second user; and establishing a digital link, using the processing unit, between the limited purpose user profile and the account of the first user in the database, the digital link identifying the electronic access right from the electronic request.

### BACKGROUND

Electronic systems may maintain user profiles in databases. The user profiles may contain various types of information associated with the user. Access privileges may be granted to allow one user profile to use data associated with another user profile. For instance, a user profile may be given an access privilege to view a profile of another user.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a schematic diagram identifying aspects of user profile data structures, according to various examples.

FIG. 3 is a mockup screenshot of an electronic access rights delegation user interface, according to various examples.

FIG. 4 is a flowchart illustrating a method to link a limited purpose user profile to an account of a full user profile, according to various examples.

FIG. 5 is a block diagram illustrating a machine in the example form of computer system, within which a set or sequence of instructions may be executed to cause the machine to perform any one of the methodologies discussed herein, according to various examples.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be performed by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless explicitly indicated as such, the use of “presenting a user interface” does not infer either one of these options.

Additionally, the elements and portions are sometimes described as being configured for a certain purpose. For example, an input element may be described as being configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

In various examples, a system may allow users enrolled in an online service to grant access rights to other enrolled users of the same service. For example, a first user may grant a second user view access to information in the user profile of the first user. If the second user already has a user profile in the system, access rights delegation may be accomplished in a relatively streamlined fashion. For example, an electronic link may be generated in a database that enumerates the access rights between the user profile of the first user and the second user. Accordingly, when the second user logs into the system, a link (or embedded view) may be presented to view the first user's profile and potentially use the account if those rights were delegated.

However, circumstances frequently arise where a first user wishes to grant access rights to an individual who does not currently have a user profile in the system. The inability to delegate access rights to non-users of the system limits the ability of the first user to grant access to individuals trusted by the first user and instead limits the choice to those with user profiles on the online service already.

One solution would be to have the non-enrolled user (referred to in this example as the second user) to create a user profile on the system. However, this solution introduces its own set of problems. First, the second user may not want to have a full user profile on the system. For example, the second user may have data privacy concerns and not want to give the system the level of personal details that would be required to create a “normal” (e.g., full) user profile on the system. Conversely, the system owners may not want to have the second user have a full user profile on the system. For example, a full (as opposed to limited purpose) user profile would include the same functionality for a second user as the first user, and thus may be require certain checks be completed on the second user prior to user profile creation. This process may create delays in the user profile creation. Additionally, in some examples, the second user may not be permitted (e.g., does not pass a security check) to have a full user profile. However, the first user may still want the second user to have access to the first user's user profile.

In view of the above problems, systems and methods are described that create a limited purpose user profile on a system that may be granted (e.g., delegated) certain electronic access rights to an existing user profile on the system. For example, when the first user attempts to delegate an access right to a second user, the system receives the delegation request and queries a database to determine whether the second user has an existing profile in the database. After determining no user profile exists for the second user, the system generates a limited purpose user profile for the second user. The system then establishes a digital link between the limited purpose user profile and the user profile of the first user in the database—with this link identifying the electronic access right(s) that was delegated.

The user of a limited purpose user profile provides several advantages over creating a full user profile on the system. In various examples, the limited purpose user profile allows for more precise scoping of access privileges to match the intended use of the user profile. The limited purpose user profile may thus designate just the specific access right delegated by the first user (and potentially other users). Additionally, the limited purpose user profile enhances security because the limited purpose user profile does not have the same functionality of a full user profile. Consequently, the limited purpose user profile may undergo less rigorous account creation procedures. Furthermore, because generated a limited purpose user profile does not require the same enrollment process, computing resources are preserved when compared to generating a full user profile.

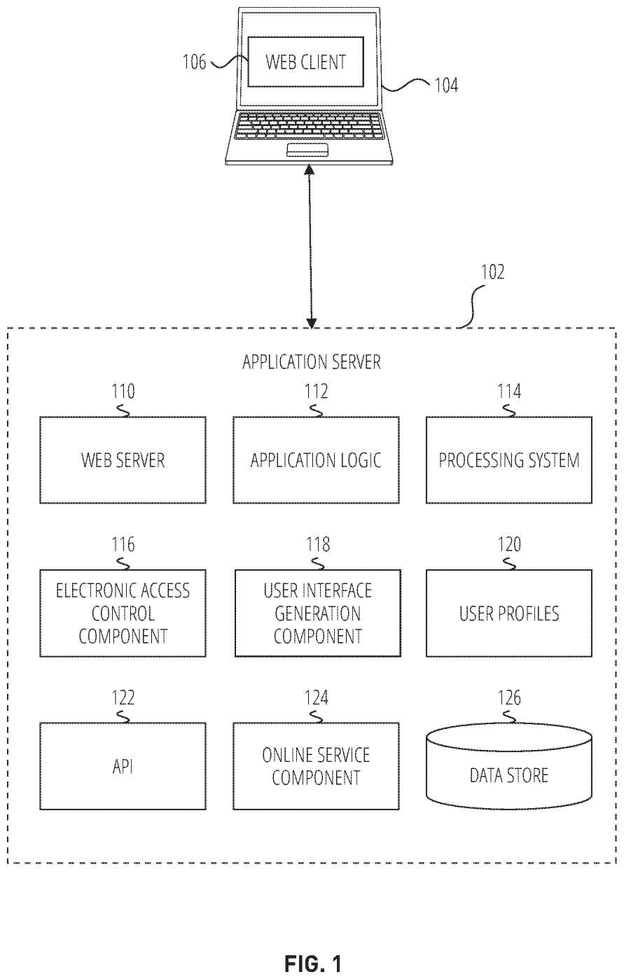

FIG. 1 is an illustration of components of a client device 104 and an application server 102, according to various examples. For example, client device 104 may be used by a first user to grant an electronic access right to an account of the user using a web application provided by application server 102. FIG. 1 includes an application server 102, a client device 104, a web client 106, a web server 110, an application logic 112, a processing system 114, an electronic access control component 116, a user interface generation component 118, a user profiles 120, an API 122, an online service component 124, and a data store 126.

Application server 102 is illustrated as set of separate elements (e.g., components). However, the functionality of multiple, individual elements may be performed by a single element. An element may represent computer program code that is executable by processing system 114. The program code may be stored on a storage device (e.g., data store 126) and loaded into a memory of the processing system 114 for execution. Portions of the program code may be executed in a parallel across multiple processing units. A processing unit may be one or more of a core of a general purpose computer processor, a graphical processing unit, an application specific integrated circuit, or a tensor processing core operating a single device or multiple devices. Accordingly, execution of the code using a processing unit may be performed on a single device or distributed across multiple devices. In some examples, the program code may be executed on a cloud platform (e.g., MICROSOFT AZURE® and AMAZON EC2®) using shared computing infrastructure.

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

In some examples, the communication may occur using an application programming interface (API) such as API 122. An API provides a method for computing processes to exchange data. A web-based API (e.g., API 122) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a database (e.g., data store 126). For example, an API call may be made to add, modify, or remove a previously granted electronic access right delegated from a first user to a second user. Data in the API call may be processed by another component of application server 102, such as electronic access control component.

Application server 102 may include web server 110 to enable data exchanges with client device 104 via web client 106. Although generally discussed in the context of delivering webpages via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

Additionally, web server 110 may enable a user to interact with one or more web applications provided in a transmitted web page. A web application may provide user interface (UI) components that are rendered on a display device of client device 104. The user may interact (e.g., select, move, enter text into) with the UI components, and, based on the interaction, the web application may update one or more portions of the web page. A web application may be executed in whole, or in part, locally on client device 104. The web application may populate the UI components with data from external sources or internal sources (e.g., data store 126) in various examples.

In various examples, the web application is an access rights delegation interface. The access rights delegation interface may be a sub application of a larger application. For example, application server 102 may implement a banking application that permits a user, via client device 104, to view the user's accounts that are associated with the user's profile. The banking application may provide functionality (e.g., online services provided by online service component 124) associated with the accounts of the user. For example, a bill pay online service may be used by the user to set up automatic payments to payees (e.g., those entities to which bills have been issued to the user) from of the user's accounts (also referred to as funding accounts).

As part of the bill pay online service, the web application may include functionality (e.g., electronic access control component 116) to delegate electronic access rights to a user's account with respect a funding account. For example, the user may be traveling and may not have access to use the bill pay online service. Accordingly, the user may delegate access to a trusted friend. The term ‘delegate’ does not imply that the granting user is unable to use the bill pay online service. Thus, the granting user (e.g., delegator) and the delegatee may both use the bill pay online service for the funding account.

An electronic access right may include an access level, duration, and limit, in various examples. Access levels may be view level access, edit level access, or full level access. For example, a view level access may grant the delegatee the ability to see the bills that are coming due and make payments from the funding account for the bills, but not change the amount paid to a bill payee (e.g., the entity that issued the bill). An edit level of access may allow the delegatee to change the amount paid to the bill payee. A full level of access may allow payment amount changes—as well as the ability to grant electronic access rights to other users as well.

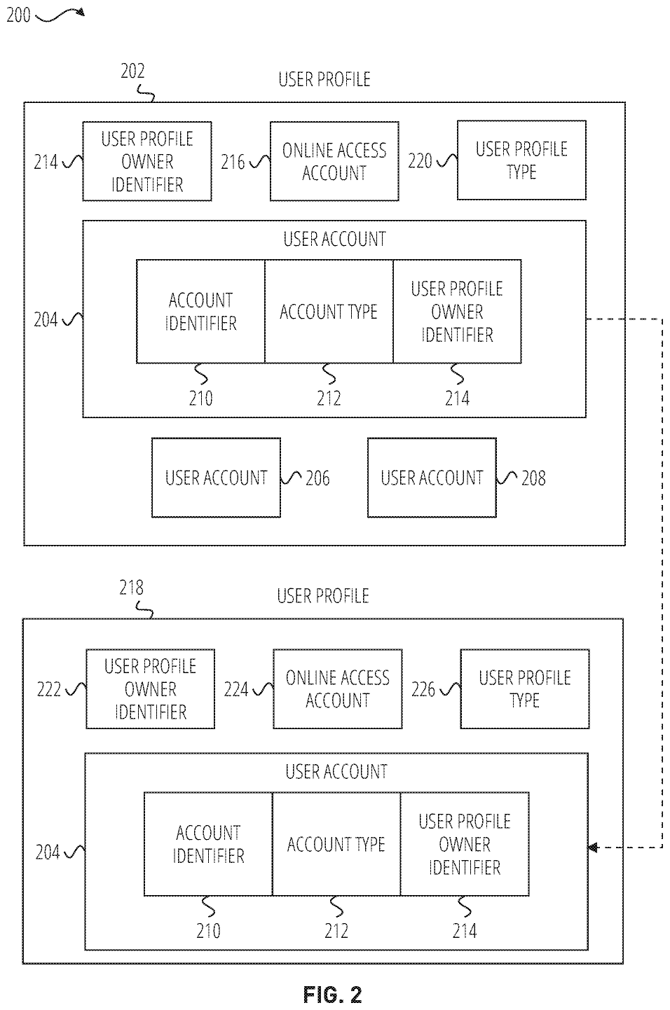

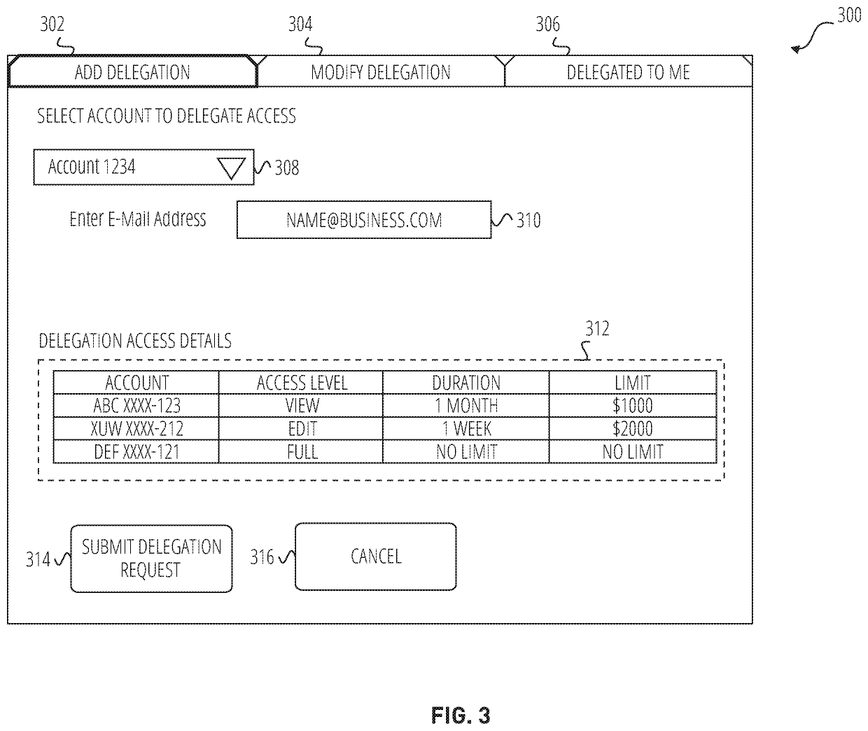

The electronic access right may also be associated with a duration and currency limit. For example, the delegatee may be limited to making payments to a bill payee up to the currency limit. The duration may identify the length of access (e.g., a month, six months, etc.) for the delegatee. After the duration has lapsed (or the user has chosen to revoke the access) data store 126 may be updated (e.g., using an API call or SQL command) to indicate the delegatee no longer has access to the delegator's funding account for bill pay online services. Further details on the access rights delegation interface and data structures for implementing the electronic access right are further described in FIG. 2 and FIG. 3.

The web application may be executed according to application logic 112. Application logic 112 may use the various elements of application server 102 to implement the web application. For example, application logic 112 may issue API calls to retrieve or store data from data store 126 and transmit it for display on client device 104. Similarly, data entered by a user into a UI component may be transmitted using API 122 back to the web server. Application logic 112 may use other elements (e.g., electronic access control component 116, user interface generation component 118, online service component 124, etc.) of application server 102 to perform functionality associated with the web application as described further herein.

Data store 126 may store data that is used by application server 102. Data store 126 is depicted as singular element, but may in actuality be multiple data stores. The specific storage layout and model used in by data store 126 may take a number of forms-indeed, a data store 126 may utilize multiple models. Data store 126 may be, but is not limited to, a relational database (e.g., SQL), non-relational database (NoSQL) a flat file database, object model, document details model, graph database, distributed ledger (e.g., blockchain), or a file system hierarchy. Data store 126 may store data on one or more storage devices (e.g., a hard disk, random access memory (RAM), etc.). The storage devices may be in standalone arrays, part of one or more servers, and may be located in one or more geographic areas.

Data structures used in data store 126 may be implemented in several manners depending on a programming language of an application or database management system used by an application. For example, if C++ is used, the data structure may be implemented as a struct or class. In the context of a relational database, a data structure may be defined in a schema.

User profiles 120 may include user profiles on users that interact with application server 102 via web server 110 and are described in more detail next with respect to FIG. 2. A user profile may include credential information such as a username and hash of a password. A user may enter in their username and plaintext password to a login page of application server 102 to view their user profile information or interfaces presented by application server 102 in various examples.

FIG. 2 is a schematic diagram identifying aspects of user profile data structures, according to various examples. The diagram 200 comprises a user profile 202, a user account 204, a user account 206, a user account 208, an account identifier 210, an account type 212, a user profile owner identifier 214, an online access account 216, a user profile 218, a user profile type 220, a user profile owner identifier 222, an online access account 224, and a user profile type 226.

Although user profile 202 and user profile 218 both visually depict an implied structure of how data may be stored, other data structure arrangements may be used. For example, data store 126 may include a user accounts table, a user profiles table, an electronic access rights table. An entry in the user profiles table may include links (e.g., cross-referenced values of primary or foreign keys) to the user accounts table and electronic access rights table.

The initial process of establishing a relationship between a user and services provided by application server 102 may be the user completing an enrollment process. If application server 102 is provided by a financial institution, the process may require proof of identity, etc., in order to comply with governmental requirements such as “know your customer” regulations. After the enrollment process, a user profile may be generated and stored on data store 126. In various examples, the enrollment process does need to be completed in an online environment. Thus, a user may physically go to a bank branch to enroll as a customer. In order to discuss the accounts of a user more easily (e.g., checking accounts, mortgage accounts) versus the user account, this disclosure uses the term “user profile” for the user account that is created after the enrollment process.

After the user profile is generated for a user, a user profile owner identifier may be generated. The user profile owner identifier may be a unique identifier that is stored in a user profile database table. After enrollment, the user may open accounts that are associated with the user profile. For example, user profile 202 has three opened accounts, user account 204, user account 206, and user account 208. An account may include an account identifier (e.g., account identifier 210 that is unique across all accounts), an account type (e.g., account type 212), and a user profile owner identifier (e.g., user profile owner identifier 214). Account types may be, but are not limited to, savings, checking, retirement, and mortgage.

“Associated” in the context of linking an account to a user profile (or other data linkages described herein) may be implemented in different manners depending on the underlying database system. For example, in a relational database management system (RDBMS), the term “associated” may refer to the relationship between tables. The relationship could be one-to-one, one-to-many, or many-to-many, established through foreign key constraints. For example, in a one-to-many relationship, a record in Table A (e.g., the user profile table) may be associated with multiple records in Table B (e.g., a user account table), using a foreign key in Table B that references the primary key in Table A.

The user profile owner identifier of an account is not necessarily the same as the as user profile owner identifier of a user profile because electronic access rights may be granted to other users. As an ongoing example depicted in FIG. 2, consider that user profile 202 is associated with a first user that has delegated electronic access rights to user account 204 to a second user-whose profile is represented as user profile 218. Consequently, user account 204 is both present in user profile 202 and user profile 218. Furthermore, it may be observed that user profile owner identifier 214 is part of user profile 202 as well as user account 204 in user profile 218.

Different user profile types (e.g., user profile type 220 and user profile type 226) may have different functionality available for use by their associated users depending the type of user profile. For example, user profile 202 may be a full user profile. A full user profile may a user profile that was created using the full enrollment process—e.g., confirming the user's identity and complying with all regulatory rules. Accordingly, a user with a full user profile is enabled to open accounts and use all the financial services offered by a financial institution associated with application server 102.

In contrast to a full user profile, a limited purpose user profile may be a user profile that was not generated using the full enrollment process. Unlike a full user profile, a user that has a limited purpose user profile is unable to open accounts or use services of the financial institution—beyond those delegated to the limited purpose user profile. For example, a limited purpose user profile may only have permissions to access those accounts which have been delegated to it from a user with a full user profile. Another distinguishing factor is that a limited purpose user profile may be generated in response to a request from a user of a full user profile. Thus, a user of a limited purpose user profile may not initiate the generation of the limited purpose user profile or have accounts of its own.

The existence of a full user profile does not infer that a user has online access to their accounts. For example, it is not uncommon for a person to have an account with a bank but not create a username and password to enable online access. However, when a user does decide they want online access, an online access account may be generated and associated with the user profile. For example, online access account 216 is the online account for user profile 202. Online access account 216 may include its own unique identifier separate from user profile owner identifier 214. As part of generating a limited purpose user profile, an online access account may automatically be generated (e.g., online access account 224).

Once a user has an online access account, the user may have additional functionality made available to them. For example, the user may enroll in a bill pay online service that lets the user pay their bills using one of their accounts (e.g., user account 204). Additionally, as a sub-function of the bill pay online service, a user may delegate access to one or more the user's accounts. As described above, the delegated access may be represented as an electronic access right. The process of delegation is discussed further in the context of FIG. 3.

FIG. 3 is a mockup screenshot of an electronic access rights delegation user interface, according to various examples. FIG. 3 illustrates an example user interface 300 including add delegation tab 302, modify delegation tab 304, delegated to me tab 306, account selection element 308, delegate user identifier 310, access rights table 312, submit element 314, and cancel element 316.

In various examples, user interface 300 may be presented in response to a user selecting a user interface element presented on web client 106 of client device 104. In various examples, user interface generation component 118 of application server 102 as depicted in FIG. 1 may generate the user interface and respond to interactions with the user interface. The user may be the user of user profile 202 and may want to delegate an electronic access right of the bill pay online service to another user. As may be observed, there may be multiple tabs available with respect to delegation of electronic access rights. The first may be the add delegation tab 302—which is currently selected as evidenced by the emphasized border. The second tab may be the modify delegation tab 304 to modify or view the status of previous delegated electronic access rights. The third tab, delegated to me tab 306, may present information on accounts that have been delegated to the user.

As part of the delegation process, a user may select an account from account selection element 308. For example, account selection element 308 may be populated with user account 204, user account 206, and user account 208 with respect to FIG. 2 based on a database query. In order to delegate the bill pay online service for an account, a user enters in delegate user identifier 310. In user interface 300, the user identifier is an email address, but other identifiers may be used such as a phone number, or if known by the user, an account identifier of the delegatee. Furthermore, more than one user identifier may be used.

User interface 300 also includes access rights table 312 in which the delegating user may determine which set of electronic access rights to grant to the delegatee. In the presented illustration, three bill payees are listed. A user may select the cells within access rights table 312 to change their values. For example, under the duration column a user may select the “1 week” duration cell and change it to six months. The bill payees may be auto-populated (e.g., using results of a database query) based on the selected account in account selection element 308—e.g., if a bill payee is paid using the selected account, it may be added to the access rights table 312. In other examples, instead of individual bill payees, a user may delegate electronic access rights at the account level. Thus, a user may grant view access to all bill payees for the selected account in account selection element 308.

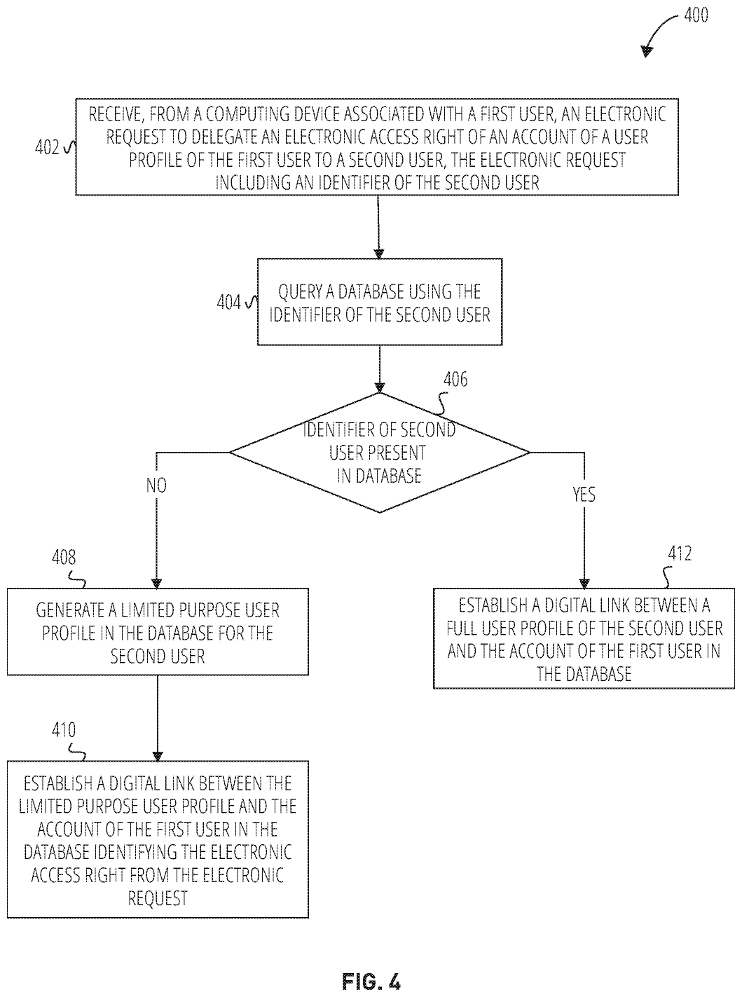

Once the electronic access rights have been set to the user's preferences, they may active (e.g., click) submit element 314 to begin the system process of delegating the access rights. This process is described in more detail in FIG. 4. If the user decides they do not want to delegate electronic access rights, they may activate cancel element 316.

FIG. 4 is a flowchart illustrating a method to link a limited purpose user profile to an account of a full user profile, according to various examples. The method is represented as a set of blocks that describe operations 402 to 410. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processor units that execute the set of instructions to configure the one or more processing units to perform the operations illustrated in FIG. 4. A processing unit of a computing device may instruct other components of the computing device(s) to carry out the set of instructions. For example, the processing unit may instruct a network device to transmit data to another computing device or the computing device may provide data over a display interface to present a user interface. In some examples, use of a processing unit causes performance of the method across multiple computing devices using a shared computing infrastructure.

According to some examples, the method includes receiving, from a computing device (e.g., client device 104) associated with a first user, an electronic request to delegate an electronic access right of an account of a user profile of the first user to a second user, the electronic request including an identifier of the second user at operation 402. For example, the first user may login to application server 102 via a web application displayed on web client 106 provided by web server 110. An interface such as user interface 300 may be presented to the user to set the level of access, duration, and a limit for the electronic access right. The account of the user profile may be a funding source for a bill payment account (e.g., a bill payee). The electronic request may be received over an API call with the values of the user selected values in the user interface as values (e.g., formatted in JavaScript Object Notation). The identifier of the second user may be an email address, in various examples.

According to some examples, the method includes querying a database using the identifier of the second user at operation 404. For example, as part of process of granting electronic access rights a check may be made to determine if the second user already has a user profile in data store 126. Accordingly, if the identifier of the second user is an email address, then the email address may be used to determine if the email address already exists in a table in data store 126.

At decision operation 406 it may be determined if the identifier of the second user was found based on the query. If yes, the method flow may continue to operation 412 in which a digital link between a full user profile of the second user and the account of the first user in the database is established. As noted previously, associating or linking two data points in a database may include using a foreign key of one database table in a row of another table. The link may be made between the online access accounts of the first and second users. Because the second user already has a full user profile, the system may add the delegated account(s) to the second user's profile. Thus, upon logging into application server 102 and navigating to the bill pay online service (e.g., by clicking a hyperlink) the second user may not only be presented with the second user's accounts, but also the accounts delegated from the first user.

If, instead, the identifier of the second user is not found (e.g., 0 results are returned) in a database as associated with a user profile, flow may continue to operation 408 where a limited purpose user profile is generated in the database for the second user. The limited purpose may be for the second user to view/edit/pay from the accounts designated by the first user. The second user may not have, or have the ability to create or be associated with, accounts of their own as part of the limited purpose user profile. Thus, any accounts that are part of the second user's user profile have a user profile owner identifier that is different than the second user. For example, the limited purpose user profile may be structured as user profile 218 with respect to FIG. 2. The limited purpose user profile may have an online access account generated for it to use for linking to the online access account of the first user.

In various examples, the method includes establishing a digital link between the limited purpose user profile and the account of the first user in the database identifying the electronic access right from the electronic request at operation 410. For example, the digital link may associate the account identifier of the account of operation 402 with the online access account of the second user profile.

Method 400 may include additional operations. For example, after the generation of the second user profile in operation 408, a request may be transmitted to a computing device associated with the second user to accept delegation of the electronic request of the account of the user profile of the first user. The transmission may come in the form an email to the second user. The email may include a link to finish setting up with the limited purpose user profile. For example, the link may take the second user to a webpage served from web server 110 and include a presentation of the delegation information (e.g., level of access, duration, etc.) from the first user and an option to create a username and password. The webpage may also include a user interface element (e.g., button) to accept the delegation. Accordingly, an indication of acceptance of the delegation may be received from the computing device associated with the second user.

After the limited purpose user profile has been generated and the second user has accepted the delegation, method 400 may include additional operations. For example, web server 110 may receive a login request associated with the limited purpose user profile. Associated may mean that a user attempting to login is using the username and password of the limited purpose user profile. In response, user interface generation component 118 and electronic access control component 116 may present a user interface with account controls for the account of the user profile of the first user based on the electronic access right. For example, the account controls may allow the second user to initiate a bill payment to a bill payee when the electronic access right grants the second user a right to initiate a payment to the bill payment account (e.g., the bill payee). In various examples, the user interface presented to the second user is the same as the user interface that would be presented to the first user if the first was logged in and making payment using the bill payment account.

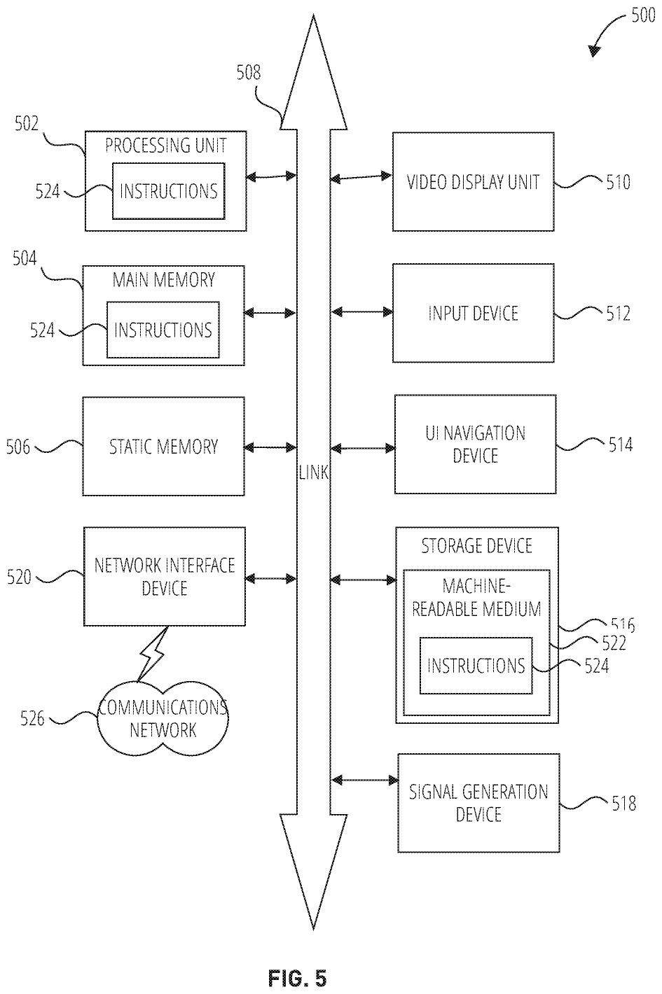

FIG. 5 is a block diagram illustrating a machine in the example form of computer system 500, within which a set or sequence of instructions may be executed to cause the machine to perform any one of the methodologies discussed herein, according to an example embodiment. In various examples, the machine operates as a standalone device, as multiple devices, or as distributed machine connected (e.g., networked) to other machines. The machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processing unit 502 (e.g., a central processing unit (CPU), a graphics processing unit (GPU) or both, processor cores, compute nodes, etc.), a main memory 504 and a static memory 506, which communicate with each other via a link 508. The computer system 500 may further include a video display unit 510, an input device 512 (e.g., a keyboard), and a user interface UI navigation device 514 (e.g., a mouse). In one embodiment, the video display unit 510, input device 512, and UI navigation device 514 are incorporated into a single device housing such as a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensors.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processing unit 502 during execution thereof by the computer system 500, with the main memory 504, static memory 506, and the processing unit 502 also constituting machine-readable media.

While the machine-readable medium 522 is illustrated in an example embodiment to be a single medium, the term “machine-readable medium” may include a single medium or multiple media (e.g., a centralized or distributed Database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 522 that excluded transitory signals.

The instructions 524 may further be transmitted or received over a communications network 526 using a transmission medium via the network interface device 520 utilizing any one of a number of well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
receiving, from a computing device associated with a first user, an electronic request to delegate an electronic access right of an account of a user profile of the first user to a second user, the electronic request including an identifier of the second user;
querying, using a processing unit, a database using the identifier of the second user;
determining, using the processing unit, that the identifier of the second user is not present in the database based on a result of the querying; and
as a result of the determining:
generating, using the processing unit, a limited purpose user profile in the database for the second user; and
establishing a digital link, using the processing unit, between the limited purpose user profile and the account of the first user in the database, the digital link identifying the electronic access right from the electronic request.

2. The method of claim 1, further comprising:
transmitting a request to a computing device associated with the second user to accept delegation of the electronic request of the account of the user profile of the first user; and
receiving from the computing device associated with the second user, an indication of acceptance of the delegation.

3. The method of claim 1, further comprising:
receiving a login request associated with the limited purpose user profile; and
in response to the login request, presenting a user interface with account controls for the account of the user profile of the first user based on the electronic access right.

4. The method of claim 3, wherein the account of the first user is identified as a funding source for a bill payment account.

5. The method of claim 4, wherein the electronic access right grants the second user a right to initiate a payment to the bill payment account from the account of the first user using the account controls.

6. The method of claim 1, wherein the limited purpose user profile is not associated with an account of the second user.

7. The method of claim 1, further comprising:
generating, using the processing unit, an online access account for the limited purpose user profile.

8. The method of claim 7, wherein establishing the digital link, using the processing unit, between the limited purpose user profile and the account of the first user in the database comprises:
associating the online access account and the account of the first user in the database.

9. A non-transitory computer-readable medium comprising instructions, which when executed by a processing unit, configure the processing unit to perform operations comprising:
receiving, from a computing device associated with a first user, an electronic request to delegate an electronic access right of an account of a user profile of the first user to a second user, the electronic request including an identifier of the second user;
querying, using a processing unit, a database using the identifier of the second user;
determining, using the processing unit, that the identifier of the second user is not present in the database based on a result of the querying; and
as a result of the determining:
generating, using the processing unit, a limited purpose user profile in the database for the second user; and
establishing a digital link, using the processing unit, between the limited purpose user profile and the account of the first user in the database, the digital link identifying the electronic access right from the electronic request.

10. The non-transitory computer-readable medium of claim 9, wherein the instructions, which when executed by the processing unit, further configure the processing unit to perform operations comprising:
transmitting a request to a computing device associated with the second user to accept delegation of the electronic request of the account of the user profile of the first user; and
receiving from the computing device associated with the second user, an indication of acceptance of the delegation.

11. The non-transitory computer-readable medium of claim 9, wherein the instructions, which when executed by the processing unit, further configure the processing unit to perform operations comprising:
receiving a login request associated with the limited purpose user profile; and
in response to the login request, presenting a user interface with account controls for the account of the user profile of the first user based on the electronic access right.

12. The non-transitory computer-readable medium of claim 11, wherein the account of the first user is identified as a funding source for a bill payment account.

13. The non-transitory computer-readable medium of claim 12, wherein the electronic access right grants the second user a right to initiate a payment to the bill payment account from the account of the first user using the account controls.

14. The non-transitory computer-readable medium of claim 9, wherein the limited purpose user profile is not associated with an account of the second user.

15. The non-transitory computer-readable medium of claim 9, wherein the instructions, which when executed by the processing unit, further configure the processing unit to perform operations comprising:
generating, using the processing unit, an online access account for the limited purpose user profile.

16. The non-transitory computer-readable medium of claim 15, wherein establishing the digital link, using the processing unit, between the limited purpose user profile and the account of the first user in the database comprises:
associating the online access account and the account of the first user in the database.

17. A system comprising:
a processing unit;
a storage device comprising instructions, which when executed by the processing unit, configure the processing unit to perform operations comprising:
receiving, from a computing device associated with a first user, an electronic request to delegate an electronic access right of an account of a user profile of the first user to a second user, the electronic request including an identifier of the second user;
querying, using a processing unit, a database using the identifier of the second user;
determining, using the processing unit, that the identifier of the second user is not present in the database based on a result of the querying; and
as a result of the determining:
generating, using the processing unit, a limited purpose user profile in the database for the second user; and
establishing a digital link, using the processing unit, between the limited purpose user profile and the account of the first user in the database, the digital link identifying the electronic access right from the electronic request.

18. The system of claim 17, wherein the instructions, which when executed by the processing unit, further configure the processing unit to perform operations comprising:
transmitting a request to a computing device associated with the second user to accept delegation of the electronic request of the account of the user profile of the first user; and
receiving from the computing device associated with the second user, an indication of acceptance of the delegation.

19. The system of claim 17, wherein the instructions, which when executed by the processing unit, further configure the processing unit to perform operations comprising:
receiving a login request associated with the limited purpose user profile; and
in response to the login request, presenting a user interface with account controls for the account of the user profile of the first user based on the electronic access right.

20. The system of claim 19, wherein the account of the first user is identified as a funding source for a bill payment account.
